(19) United States
(12) Patent Application Publication
(10) Pub. No.: US 2014/0374436 A1
(43) Pub. Date: Dec. 25, 2014

(54) DISPENSING DEVICE

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: CHIN-WEN YEH, New Taipei (TW); YANG XIAO, Wuhan (CN); JIN-XIN WANG, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/205,412

(22) Filed: Mar. 12, 2014

(30) Foreign Application Priority Data
Jun. 20, 2013 (CN) 2013102457021

(51) Int. Cl. G07F 11/00; G07F 11/28

(52) U.S. Cl. CPC G07F 11/005; G07F 11/28
USPC 221/123

(57) ABSTRACT

A dispensing device includes a receiving tray and a delivery mechanism. The receiving tray includes two side plates to receive products. The delivery mechanism is secured to the two side plates and includes a blocking board and a stopping member. The blocking board is hung on the receiving tray, and the stopping member is secured to the receiving tray. The blocking board is located in a first position, where the blocking board blocks one of the products from disengaging from the receiving tray. The blocking board is rotatable about an axis that is substantially perpendicular to the side plates to a second position, where the blocking board is disengaged from the products, and the stopping member is rotatable with the blocking board for blocking the other products from moving out of the receiving tray.

### BACKGROUND

1. Technical Field

The present disclosure relates to dispensing devices, and particularly to a dispensing device in an automatic vending machine.

2. Description of Related Art

Vending machines allow customers to buy products twenty-four hours a day. When the customer purchases a product, a helical element in a cabinet is rotated to push the product out of the cabinet. However, sometimes the product drops out of the cabinet when the cabinet is shaken, and sometimes the product gets stuck in the helical element. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a dispensing device in accordance with an embodiment.

FIG. 2 is an exploded, isometric view of a delivery mechanism of FIG. 1.

FIG. 3 is an assembled view of the delivery mechanism of FIG. 2.

FIG. 4 is an assembled view of the dispensing device of FIG. 1.

FIG. 5 is a side view of the dispensing device of FIG. 2, a blocking board is closed.

FIG. 6 is a side view of the dispensing device of FIG. 2, a blocking board is open.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

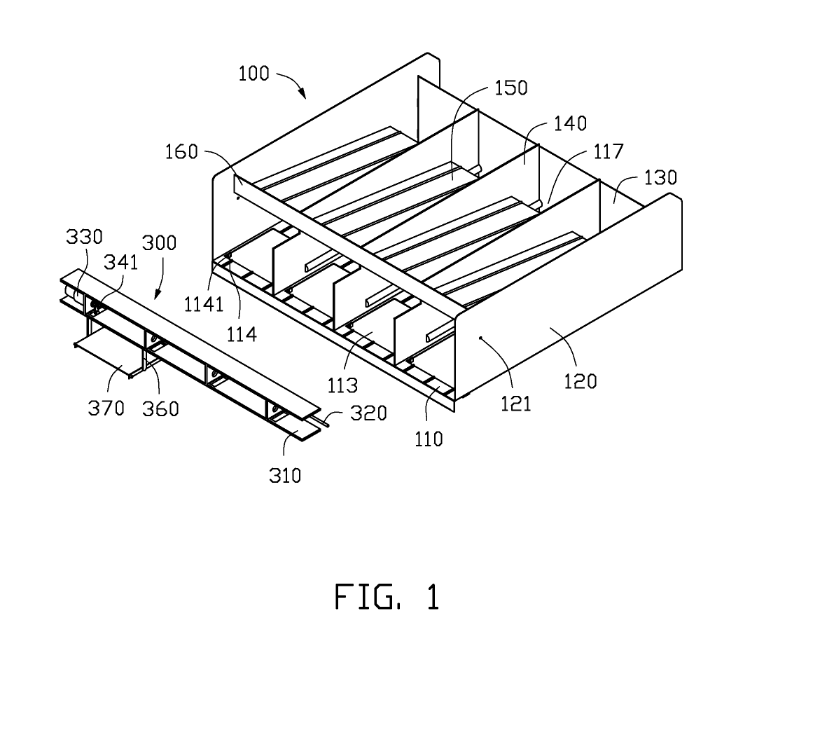

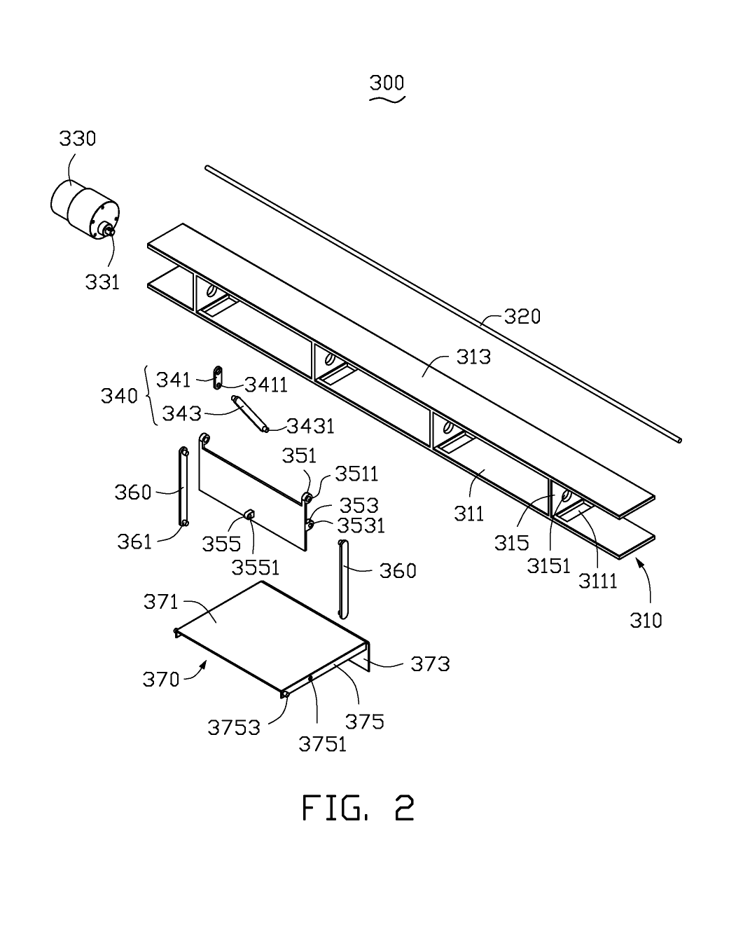

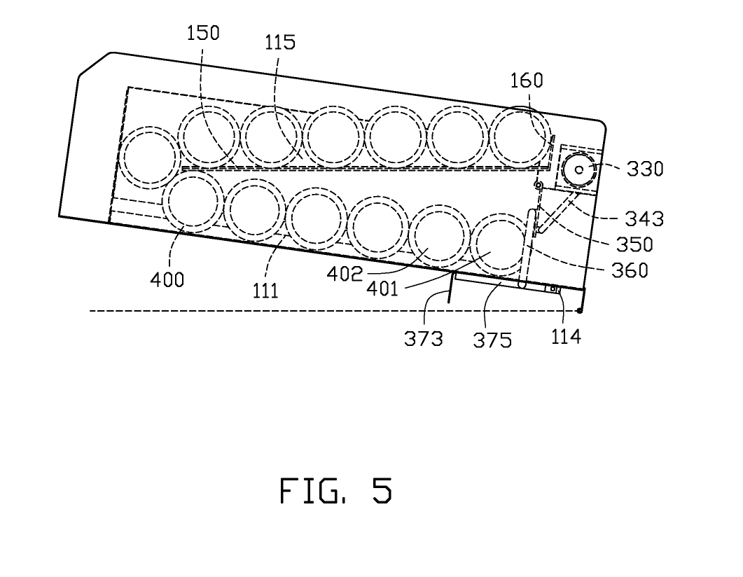

FIGS. 1-2 illustrate an embodiment of a dispensing device. The dispensing device includes a receiving tray 100 and a delivery mechanism 300. The receiving tray 100 is used for receiving a plurality of products 400 (shown in FIG. 5). In one embodiment, the dispensing device is placed in a cabinet of the automatic vending mechanism (not shown), and each of the products 400 has a cylindrical contour.

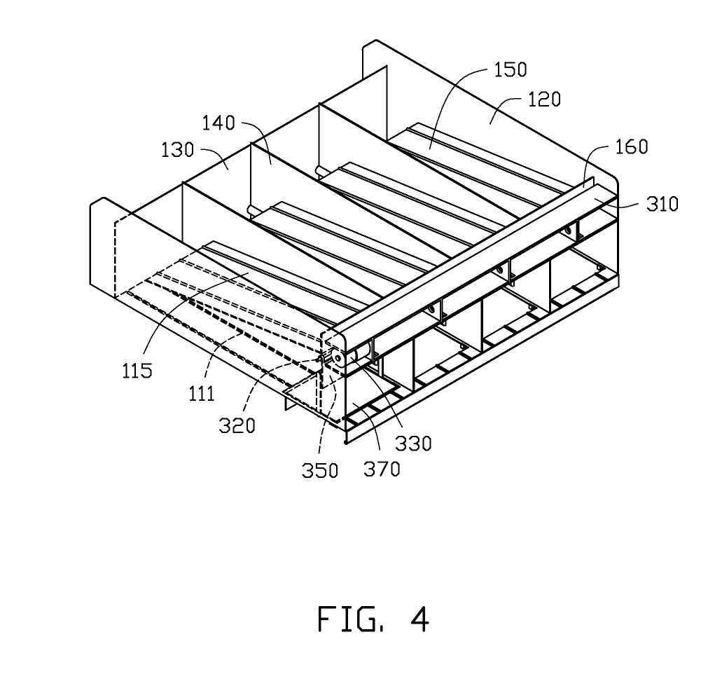

The receiving tray 100 includes a bottom plate 110, two side plates 120, a rear plate 130, and a plurality of separating plates 140. The two side plates 120 extend upwards from two opposite edges of the bottom plate 110. The plurality of separating plates 140 are installed on the bottom plate 110 and located between the two side plates 120. The plurality of separating plates 140 are substantially parallel to each other and parallel to the two side plates 120. The two side plates 120 and the plurality of separating plates 140 are substantially perpendicular to the bottom plate 110. The rear plate 130 extends upwards from a rear edge of the bottom plate 110 and is connected to the two side plates 120. The bottom plate 110, the rear plate 130, and two adjacent separating plates 140 or adjacent one of the plurality of separating plates 140 and one of the two side plates 120 cooperatively define a first passage 111 (shown in FIG. 4). The bottom plate 110 defines an installation opening 130 corresponding to each first passage 111. Two installation tabs 114 are located on the bottom plate 110, corresponding to each first passage 111 and arranged at each installation opening 130. Each installation tab 114 defines an installation hole 1141. Each of the two side plates 120 defines a through hole 121.

The receiving tray 100 further includes a plurality of holding plates 150 and a front plate 150. Each holding plate 150 is obliquely installed between two adjacent separating plates 140, or one of the plurality of separating plates 140 and one of the two side plates 120. Each holding plate 150 is oblique in a direction towards the rear plate 130. Each holding plate 150, the two adjacent separating plates 140 or the one of the plurality of separating plates 140 and the one of the two side plates 120, and the rear plate 130 cooperatively define a second passage 115. An acute angle is defined between each holding plate 150 and the bottom plate 110. A space 117 is defined between each holding plate 150 and the rear plate 130 so that the first passage 111 is in communication with the second passage 115. A minimum width of the space 117 is slightly greater than a diameter of a cross-section of the product 400. The front plate 160 is installed to the two side plates 120 and connected to a front end of each holding plate 150, to prevent the product 400 from moving out of each holding plate 150.

The delivery mechanism 300 includes a bracket 310, a supporting pole 320, a plurality of driving members 330 (only one is shown in FIG. 4), a plurality of connecting members 340, a plurality of blocking boards 350, a plurality of linking arms 360, and a plurality of stopping members 370. The number of driving members 330, the number of connecting members 340, the number of the blocking boards 350, the number of pairs of linking arms 360, and the number of the stopping members 370 are equal. A driving shaft 331 is formed in each driving member 330. The driving member 330 may be motor.

The bracket 310 includes a first clipping plate 311, a second clipping plate 313, and a plurality of securing plates 315. The first clipping plate 311 and the second clipping plate 313 are respectively secured to the two side plates via a well know manner, such as welding, or a fastener, for example. The first clipping plate 311 and the second clipping plate 313 are parallel to each other and abut the front plate 160. The plurality of securing plates 315 are installed between the first clipping plate 310 and the second clipping plate 313 equidistantly. Each of the plurality of securing plates 315 defines a securing hole 3151 corresponding to each of the plurality of driving members 330. The first clipping plate 311 defines a cutout 3111 corresponding to each connecting member 340. The supporting pole 320 is rotatably secured to the two side plates 120 through the through hole 121.

Each of the plurality of connecting members 340 includes a first connecting arm 341 and a second connecting arm 343. Two connecting holes 3411 are defined in the first connecting arm 341 and respectively adjacent to two opposite ends of the first connecting arm 341. Two engaging posts 3431 are located on the second connecting arm 343 and respectively adjacent to two opposite ends of the second connecting arm 343. One of the two engaging posts 3431 is engaged in one of the two connecting holes 3411, to connect the second connecting arm 343 with the first connecting arm 341. In another embodiment, the first connecting arm 341 is integrated with the second connecting arm 343.

Each blocking board 350 is substantially rectangular. Two rotating tabs 351 are located on a top edge of the blocking board 350, and a rotating hole 3511 is defined in each of the two rotating tabs 351. Two hanging tabs 353 extend upwards from two opposite sides of the blocking board 350, and a first hanging hole 3531 is defined in each of the two hanging tabs 353. A protrusion 355 is located on the blocking board 350 and defines a latching hole 3551.

Two latching posts 361 are located on each linking arm 360. One of the two latching posts 361 is engaged in corresponding first hanging hole 3531, to hang the linking arm 360 to the blocking board 350.

Each stopping member 370 includes a supporting board 371, a resisting board 373, and two flanges 375. The size of the supporting board 371 is slightly smaller than the size of the installation opening 113 so that the supporting board 371 is received in corresponding installation opening 113 to prevent the product 400 from disengaging from the receiving tray 100. The resisting board 373 extends from a rear edge of the supporting board 371 and substantially perpendicular to the supporting board 371. The two flanges 375 extend from two edges of the supporting board 371 and substantially perpendicular to the supporting board 371. Each of the two flanges 375 defines a second hanging hole 3751 and is arranged at a middle portion of corresponding flange 375. A pivot post 3753 is located on each of the two flanges 375 and adjacent to a front end of each flange 375.

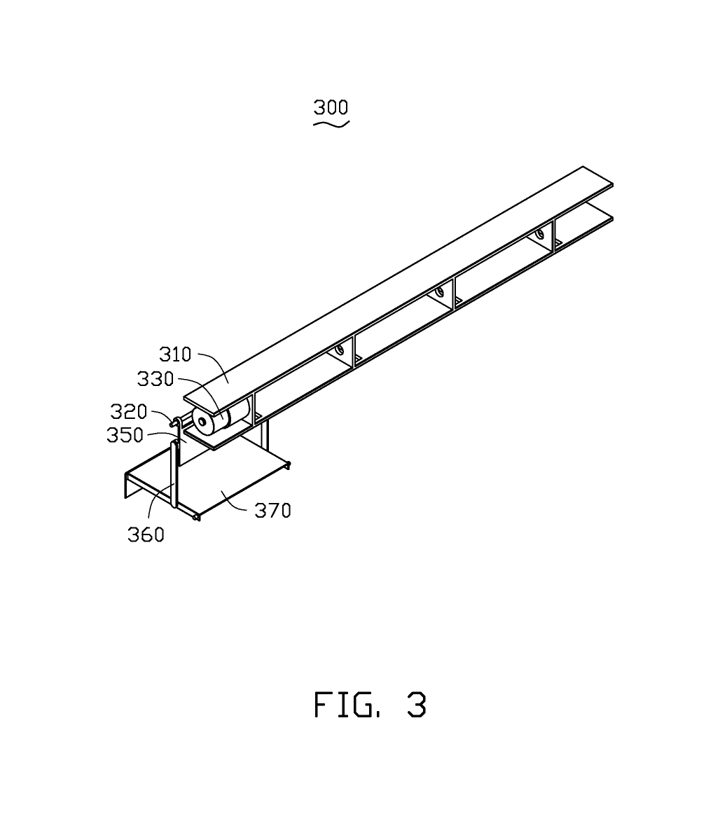

FIGS. 3-5 show that, in one embodiment, the installation of one driving member 330, one connecting member 340, one blocking board 350, two linking arms 360, and one stopping member 370 is described as an example. The driving shaft 331 extends through one of the securing holes 3151, and the driving member 330 is secured to one of the plurality of securing plates 315. The stopping member 370 is received in one of the installation openings 113, and the pivot post 3753 is engaged into the installation hole 1141, to rotatably secure the stopping member 370 to the bottom plate 110.

The blocking board 350 rotatably surrounds the supporting pole 320 by the supporting pole 320 being inserted into the rotating hole 3511 of each rotating tab 351. The supporting pole 320 is engaged into the through hole 121 of each side plate 120. One of the two latching posts 360 of each hanging arm 360 is engaged in the first hanging hole 3531, another of the two latching posts of each hanging arm 360 is engaged in the second hanging hole 3751, such that the two hanging arms 360 are connected to the blocking board 350 and the stopping member 370. The first connecting arm 341 is connected with the second connecting arm 343 by one of the two engaging posts 3431 being engaged in one of the two connecting holes 3411. Another of the two connecting holes 3411 receives the driving shaft 331, and another of the two engaging posts 3431 is engaged in the latching hole 3551.

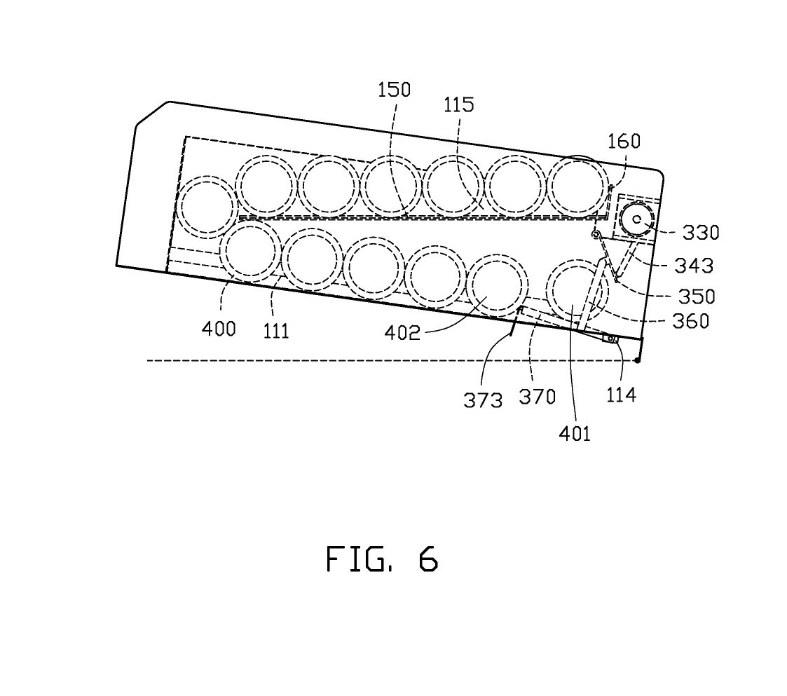

FIGS. 5 and 6 show that, in use, the first passage 111 and the second passage 115 are filled with the products 400. In this embodiment, a first product 401 and a second product 402 are taken for example . The blocking board 350 is located in a closed position, where the blocking board 350 blocks the first product 401 and is substantially perpendicular to the supporting board 371, and the supporting board 371 supports the first product 401. The driving member 330 drives the driving shaft 231 in anticlockwise, and the driving shaft 231 rotates the connecting member 340, and the connecting member 340 pushes the blocking member 350 to abut the first product 401, to prevent the first product 401 from disengaging out of the receiving tray 100.

When the product 400 is needed, the driving member 330 drives the driving shaft 331 in a clockwise. The driving shaft 331 rotates the first connecting arm 341, and the second connecting arm 343 rotates along with the first connecting arm 341. The second connecting arm 343 pulls the blocking board 350. The blocking board 350 rotates about an axis that is perpendicular to the two side plates 120 and parallel to the hanging pole 320 to an open position, where the blocking board 350 rotates away from the first product 401 and disengages from the first product 401. Simultaneously, the blocking board 350 pulls the stopping member 370 via the two hanging arms 360, such that the stopping member 370 is rotatable and the resisting board 373 moves up to block the second product 402 from moving out of the receiving tray 100. An acute angle is defined between the supporting board 371 and the bottom plate 110, such that the first product 401 moves down from the receiving tray 100 along the supporting board 371.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A dispensing device comprising:
a receiving tray configured to receive a plurality of products; and
a delivery mechanism comprising a blocking board and a stopping member, the blocking board suspended from the receiving tray, and the stopping member secured to the receiving tray and being rotatable with the blocking board;
wherein the blocking board is rotatable relative to the receiving tray between a closed position and an open position; when the blocking board is located in the closed position, the blocking board is configured to block the plurality of products from disengaging from the receiving tray, and the stopping member supports one of the plurality of products; when the blocking board is located in the open position, the blocking board is disengaged from the plurality of products, to allow the one of the plurality of products to slide from the receiving tray, and the stopping member is tilted relative to the receiving tray to block the other of the plurality of products from dispensing.

2. The dispensing device of claim 1, wherein the delivery mechanism comprises a supporting pole secured to the receiving tray, the blocking board rotatably hangs on the supporting pole.

3. The dispensing device of claim 1, wherein the delivery mechanism further comprises two linking arms, the two linking arms are connected to the blocking board and the stopping member.

4. The dispensing device of claim 3, wherein the receiving tray comprises a bottom plate, the stopping member comprises a supporting board and a resisting board extending from the supporting board; when the blocking board is located in the closed position, the supporting board supports the one of the plurality of products and has a same plane with the bottom plate, the resisting board is substantially perpendicular to the bottom plate, and the blocking board is substantially perpendicular to the supporting board; when the blocking board is located in the open position, an acute angle is defined between the supporting board and the bottom plate, the resisting board blocks the other of the plurality of products.

5. The dispensing device of claim 5, wherein the two linking arms are parallel to each other and perpendicular to the supporting board.

6. The dispensing device of claim 5, wherein the bottom plate defines an installation opening, the stopping member is received in the installation opening, one end of the stopping member opposite to the blocking member is pivotably secured to the bottom plate.

7. The dispensing device of claim 1, wherein the delivery mechanism further comprise a connecting member and a driving member, the connecting member is connected to the driving member and the blocking board, the blocking board is rotatable with the connecting member, and the connecting member is rotatable with the driving member.

8. The dispensing device of claim 4, wherein the receiving tray further comprises a side plate, a rear plate, a separating plate, the side plate and the rear plate extend from two adjacent edges of the bottom plate, the separating plate is located on the bottom plate; the bottom plate, the side plate, the rear plate, and the separating plate cooperatively define a first passage.

9. The dispensing device of claim 8, wherein the receiving tray further comprises a holding plate located between the side plate and the separating plate, and the side plate, the separating plate, the rear plate, and the holding plate cooperatively define a second passage in communication with the first passage.

10. The dispensing device of claim 9, wherein the holding plate is oblique towards the rear plate, and a space is defined between the rear plate and the holding plate.

11. A dispensing device comprising:
a receiving tray comprising two side plates and configured to receive a plurality of products; and
a delivery mechanism secured to the two side plates and comprising a blocking board and a stopping member, the blocking board suspended on the receiving tray, and the stopping member secured to the receiving tray;
wherein the blocking board is located in a first position, where the blocking board is configured to block one of the plurality of products from disengaging from the receiving tray, and the stopping member is located under the one of the plurality of products; the blocking board is rotatable about an axis that is substantially perpendicular to the side plates to a second position, where the blocking board is disengaged from the one of the plurality of products, and the stopping member is rotatable with the blocking board to block the other of the plurality of products from moving out of the receiving tray.

12. The dispensing device of claim 11, wherein the delivery mechanism comprises a supporting pole secured to the receiving tray, the blocking board rotatably hangs on the supporting pole.

13. The dispensing device of claim 11, wherein the delivery mechanism further comprises two linking arms, the two linking arms are connected to the blocking board and the stopping member.

14. The dispensing device of claim 13, wherein the receiving tray comprises a bottom plate, the stopping member comprises a supporting board and a resisting board extending from the supporting board; when the blocking board is located in the closed position, the supporting board supports the one of the plurality of products and has a same plane with the bottom plate, the resisting board is substantially perpendicular to the bottom plate, and the blocking board is substantially perpendicular to the supporting board; when the blocking board is located in the open position, an acute angle is defined between the supporting board and the bottom plate, the resisting board blocks the other of the plurality of products.

15. The dispensing device of claim 15, wherein the two linking arms are parallel to each other and perpendicular to the supporting board.

16. The dispensing device of claim 15, wherein the bottom plate defines an installation opening, the stopping member is received in the installation opening, one end of the stopping member opposite to the blocking member is pivotably secured to the bottom plate.

17. The dispensing device of claim 11, wherein the delivery mechanism further comprise a connecting member and a driving member, the connecting member is connected to the driving member and the blocking board, the blocking board is rotatable with the connecting member, and the connecting member is rotatable with the driving member.

18. The dispensing device of claim 14, wherein the receiving tray further comprises a side plate, a rear plate, a separating plate, the side plate and the rear plate extend from two adjacent edges of the bottom plate, the separating plate is located on the bottom plate; the bottom plate, the side plate, the rear plate, and the separating plate cooperatively define a first passage.

19. The dispensing device of claim 18, wherein the receiving tray further comprises a holding plate located between the side plate and the separating plate, and the side plate, the separating plate, the rear plate, and the holding plate cooperatively define a second passage in communication with the first passage.

20. The dispensing device of claim 19, wherein the holding plate is oblique towards the rear plate, and a space is defined between the rear plate and the holding plate.
